(19) United States
(12) Patent Application Publication
(10) Pub. No.: US 2003/0076565 A1
(43) Pub. Date: Apr. 24, 2003

(54) Optical communication module

(76) Inventors: Takatoshi Noda, Kanagawa (JP); Kazunobu Katou, Chiba (JP)

Correspondence Address: HOGAN & HARTSON L.L.P., 500 S. GRAND AVENUE, SUITE 1900, LOS ANGELES, CA, 90071-2611, US

(21) Appl. No.: 10/259,175

(22) Filed: Sep. 27, 2002

(30) Foreign Application Priority Data
Oct. 2, 2001 (JP) 2001-306219

(51) Int. Cl. G02F 1/00; G02F 2/00; H01S 3/00; H04B 10/00; H04J 14/00

(52) U.S. Cl. 359/163; 359/109

(57) ABSTRACT

An optical communication module according to an aspect of this invention includes: a module casing; a conversion element housed in the module casing, and performing at least one of conversion from an electric signal to an optical signal and conversion from an optical signal to an electric signal; a signal processing circuit element performing signal processing, which is housed in the module casing and connected to the conversion element; and a heat conduction member, which contacts the module casing and the signal processing circuit element when a temperature of the atmosphere in the module casing is above the operational temperature range of the signal processing circuit element, but which parts from the signal processing element when a temperature of the atmosphere in the module casing is below the operational temperature range.

### CROSS-REFERENCE TO RELATED APPLICATIONS

This application is based upon and claims the benefit of priority from the prior Japanese Patent Application No. 2001-306219, filed on Oct. 2, 2001, the entire contents of which are incorporated herein by reference.

### BACKGROUND OF THE INVENTION

1. Field of the Invention

The present invention relates to an optical communication module including a conversion element performing at least one of the conversion from an electric signal to an optical signal, and the conversion from an optical signal to an electric signal.

2. Related Background Art

An optical communication module typically includes a conversion element performing at least one of the conversion from an electric signal to an optical signal and the conversion from an optical signal to an electric signal, and a signal processing circuit element performing signal processing, which is connected to the conversion element. The signal processing circuit element has a predetermined range in element temperature so that the operation of the circuit can be secured. In accordance with the predetermined temperature range of the signal processing circuit element, the operational temperature range of the optical communication module is determined. When an optical communication module should be operated under a high-temperature environment, it is necessary to release the heat generated in the signal processing circuit element so that the element temperature of the signal processing circuit element is lowered, resulting in that the signal processing circuit element can be operated in the operational temperature range. For this purpose, a heat conduction plate, such as a metal plate, contacting the signal processing circuit element to release the heat generated in the element to the atmosphere is attached to the casing of the optical communication module.

FIG. 7 shows the structure of a conventional optical communication module. This optical communication module includes a module casing 2 of a metal. A printed circuit board 5 is housed in the module casing 2. A conversion element 6 performing at least one of the conversion from an electric signal to an optical signal and the conversion from an optical signal to an electric signal, and a signal processing circuit element 8 performing signal processing, which is connected to the conversion element 6 via wiring (not shown) of the printed circuit board 5, are mounted on the printed circuit board 5. An optical fiber 4 is connected to the conversion element 6 so that optical signals can be sent to/from the outside. A heat conduction plate 20 releasing heat generated in the signal processing circuit element 8 is provided so as to contact the module casing 2 and the signal processing circuit element 8. Pins 3 fixing the module casing 2, or electrically connecting the module casing 2 with other apparatus are attached to the lower surface of the module casing 2.

In the conventional optical communication module thus constituted, under a high-temperature environment, the heat generated in the signal processing circuit element 8 escapes to the module casing 2 via the heat conduction plate 20, so that the signal processing circuit element 8 operates within the operational temperature range. However, under a low-temperature environment, the heat generated in the signal processing circuit element 8 also escapes to the module casing 2 via the heat conduction plate 20, resulting in that the signal processing circuit element 8 should operate at a temperature below the operational temperature range. This may cause a malfunction.

### SUMMARY OF THE INVENTION

An optical communication module according to an aspect of the present invention includes: a module casing; a conversion element housed in the module casing, and performing at least one of conversion from an electric signal to an optical signal and conversion from an optical signal to an electric signal; a signal processing circuit element performing signal processing, which is housed in the module casing and connected to the conversion element; and a heat conduction member, which contacts the module casing and the signal processing circuit element when a temperature of the atmosphere in the module casing is above the operational temperature range of the signal processing circuit element, but which parts from the signal processing element when a temperature of the atmosphere in the module casing is below the operational temperature range.

### BRIEF DESCRIPTION OF THE DRAWINGS

FIGS. 1(a) and 1(b) are sectional views showing the structure of an optical communication module according to the first embodiment of the present invention.

FIGS. 2(a) and 2(b) are sectional views showing the structure of a modified version of the optical communication module according to the first embodiment of the present invention.

FIGS. 3(a) and 3(b) are sectional views showing the structure of an optical communication module according to the second embodiment of the present invention.

FIGS. 4(a) and 4(b) are sectional views showing the structure of an optical communication module according to the third embodiment of the present invention.

FIGS. 5(a) and 5(b) are sectional views showing the structure of an optical communication module according to the fourth embodiment of the present invention.

FIGS. 6(a) and 6(b) are sectional views showing the structure of an optical communication module according to the fifth embodiment of the present invention.

FIG. 7 is a sectional view showing the structure of a conventional optical communication module.

### DESCRIPTION OF THE EMBODIMENTS

Hereinafter, the optical communication module according to embodiments of the present invention will be specifically described with reference to the accompanying drawings.

(First Embodiment)

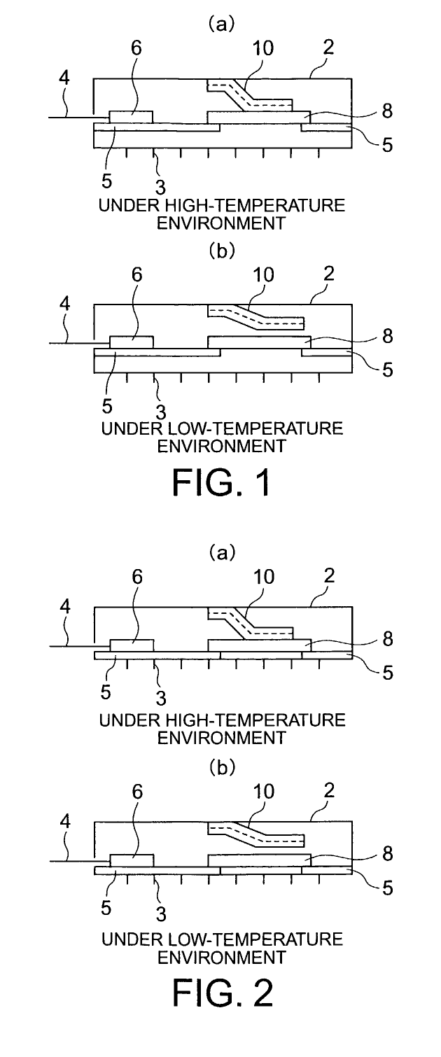

The structure of an optical communication module according to the first embodiment of the present invention is shown in FIG. 1. FIG. 1(a) is a sectional view showing the state of the optical communication module of the first embodiment under a high-temperature environment. FIG. 1(b) is a sectional view showing the state of the optical communication module of the first embodiment under a low-temperature environment.

The optical communication module of the first embodiment includes a module casing 2 of a metal, a printed circuit board 5 housed in the module casing 2, a conversion element 6 mounted on the printed circuit board 5, performing at least one of the conversion from an electric signal to an optical signal and the conversion from an optical signal to an electric signal, a signal processing circuit element 8 processing a signal, which is connected to the conversion element 6 via the wiring (not shown) of the printed circuit board 5, and a heat conduction plate 10. An optical fiber 4 is connected to the conversion element 6 in order to transmit an optical signal to/from the outside. Pins 3 are attached to the lower surface of the module casing 2 so as to fix the module casing 2 or to electrically connect the module casing 2 with other apparatus. The peripheral portion of the signal processing circuit element 8 contacts the printed circuit board 5. However, since there is an opening in the printed circuit board 5 at the portion corresponding to the central portion of the signal processing circuit element 8, the central portion of the signal processing circuit element 8 does not contact the printed circuit board 5.

The heat conduction plate 10 of this embodiment is formed of, e.g., a bimetal. Under a high-temperature environment, the heat conduction plate 10 bends to contact the upper surface of the module casing 2 and the signal processing circuit element 8 (FIG. 1(a)), and under a low-temperature environment, the heat conduction plate 10 unbends, so that although it contact the upper surface of the module casing 2, it does not contact the signal processing circuit element 8 (FIG. 1(b)).

Accordingly, under a high-temperature environment, the heat generated in the signal processing circuit element 8 escapes to the atmosphere via the module casing 2, so that the temperature of the signal processing circuit element 8 is maintained within the operational temperature range.

Under a low-temperature environment, the heat conduction plate 10 parts from the signal processing circuit element 8, as shown in FIG. 1(b). Accordingly, the heat generated in the signal processing circuit element 8 does not escape therefrom. Thus, the temperature of the signal processing circuit element 8 is maintained within the operational temperature range. Therefore, under a low-temperature environment, it is possible to lower the operational temperature of the present invention as compared with conventional optical communication modules, resulting in that it is possible to achieve an optical communication module having a wider operational temperature range.

As described above, in this embodiment, the signal processing circuit element 8 does not release the heat generated therein under a low-temperature environment. Accordingly, it is possible to maintain the temperature thereof within its operational temperature range, thereby preventing a malfunction.

Although there is a space between the lower surface of the module casing 2 and the printed circuit board 5 in the first embodiment, it is possible to obtain the same advantageous effect if the printed circuit board 5 contacts the lower surface of the module casing 2, as shown in FIG. 2(a) and 2(b). FIG. 2(a) is a sectional view showing the state of an optical communication module according to a modification of the first embodiment under a high-temperature environment, and FIG. 2(b) is a sectional view showing the state of an optical communication module according to the modification of the first embodiment under a low-temperature environment.

(Second Embodiment)

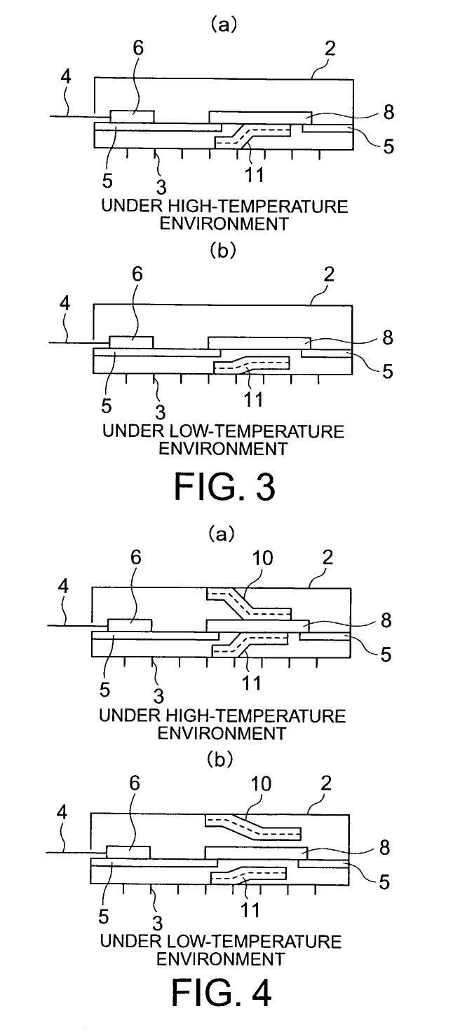

Next, the structure of an optical communication module according to the second embodiment of the present invention is shown in FIG. 3. FIG. 3(a) is a sectional view showing the state of the optical communication module of the second embodiment under a high-temperature environment. FIG. 3(b) is a sectional view showing the state of the optical communication module of the second embodiment under a low-temperature environment.

The optical communication module of this embodiment is achieved by providing the heat conduction plate of the optical communication module of the first embodiment shown in FIG. 1 to the space between the lower surface of the module casing 2 and the printed circuit board 5 instead of the space between the upper surface of the module casing 2 and the printed circuit board 5. Under a high-temperature environment, this heat conduction plate 11 bends to contact the lower surface of the module casing 2 and the signal processing circuit element 8 (FIG. 3(a)), while under a low-temperature environment, it unbends so that although it contacts the lower surface of the module casing 2, it does not contact the signal processing circuit element 8 (FIG. 3(b)).

Accordingly, under a high-temperature environment, the heat generated in the signal processing circuit element 8 escapes to the atmosphere via the module casing 2, so that the temperature of the signal processing circuit element 8 is maintained within the operational temperature range.

Under a low-temperature environment, the heat conduction plate 11 parts from the signal processing circuit element 8, as shown in FIG. 3(b). Accordingly, the heat generated in the signal processing circuit element 8 does not escape. Thus, the temperature of the signal processing circuit element 8 is maintained within the operational temperature range. Therefore, under a low-temperature environment, it is possible to lower the operational temperature of this embodiment as compared with conventional optical communication modules, resulting in that it is possible to achieve an optical communication module having a wider operational temperature range.

As described above, in this embodiment, the signal processing circuit element 8 does not release the heat generated therein under a low-temperature environment. Accordingly, it is possible to maintain the temperature thereof within its operational temperature range, thereby preventing a malfunction.

(Third Embodiment)

Next, the structure of an optical communication module according to the third embodiment of the present invention is shown in FIG. 4. FIG. 4(a) is a sectional view showing the state of the optical communication module of the third embodiment under a high-temperature environment. FIG. 4(b) is a sectional view showing the state of the optical communication module of the third embodiment under a low-temperature environment.

The optical communication module of this embodiment is achieved by providing the heat conduction plate 11 of, e.g., a bimetal, to the space between the lower surface of the module casing 2 and the signal processing circuit element 8 of the optical communication module of the first embodiment shown in FIG. 1. That is, the third embodiment is obtained by combining the first embodiment shown in FIG. 1 and the second embodiment shown in FIG. 2.

Accordingly, as in the case of the first and the second embodiments, under a low-temperature environment, the signal processing circuit element 8 does not release the heat it generates. Accordingly, it is possible to maintain the temperature of the signal processing circuit element 8 within its operational temperature range, thereby preventing a malfunction.

Moreover, as in the case of the first and the second embodiments, under a low-temperature environment, it is possible to lower the operational temperature of this embodiment as compared with the conventional optical communication modules. Accordingly, it is possible to achieve an optical communication module having a wider operational temperature range.

(Fourth Embodiment)

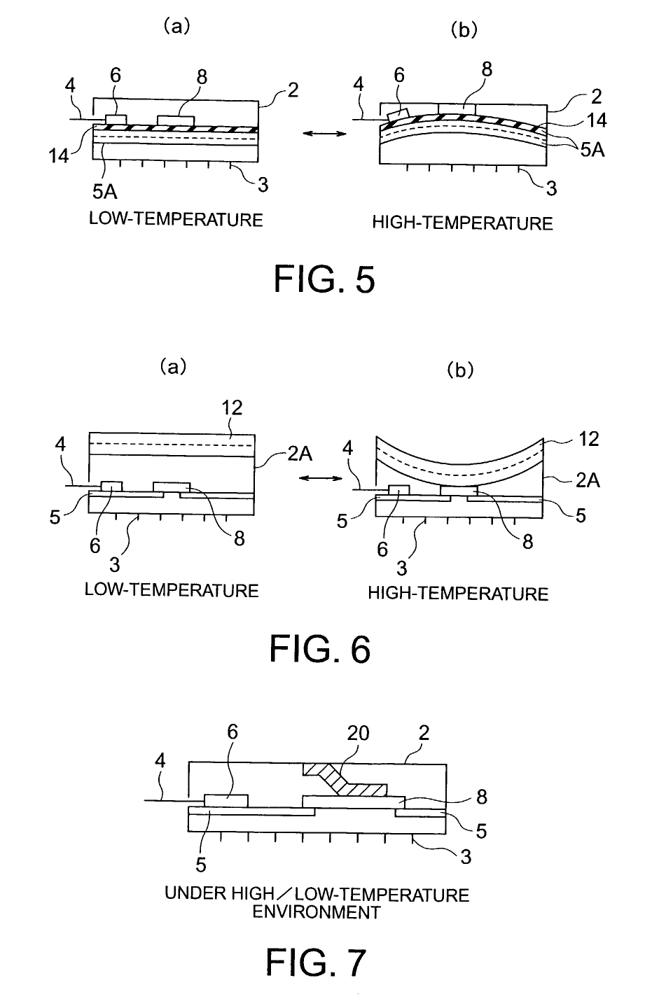

Next, the structure of an optical communication module according to the fourth embodiment of the present invention is shown in FIG. 5. FIG. 5(a) is a sectional view showing the state of the optical communication module of the fourth embodiment under a low-temperature environment. FIG. 5(b) is a sectional view showing the state of the optical communication module of the fourth embodiment under a high-temperature environment.

The optical communication module of the fourth embodiment is achieved by removing the heat conduction plate 10 from the optical communication module of the first embodiment shown in FIG. 1, and replacing the printed circuit board 5 with a printed circuit board 5A and an insulating layer 14 formed thereon. The printed circuit board 5A is formed of, e.g., a bimetal. Under a low-temperature environment, the printed circuit board 5A is flat as shown in FIG. 5(a). However, under a high-temperature environment, the printed circuit board 5A curves toward the upper surface of the module casing 2 to become a convex shape, so that the signal processing circuit element 8 formed on the insulating layer 14 contacts the upper surface of the module casing 2. The conversion element 6 is also formed on the insulating layer 14 formed on the printed circuit board 5A. In addition, the wiring (not shown) connecting the conversion element 6 and the signal processing circuit element 8 is also formed on the insulating layer 14.

Under a high-temperature environment, the printed circuit board 5A of the optical communication module of this embodiment bends so that the signal processing circuit element 8 contacts the upper surface of the module casing 2. Accordingly, the heat generated in the signal processing circuit element 8 escapes to the outside via the module casing 2, resulting in that the temperature of the signal processing circuit element 8 is maintained within the operational temperature range.

Under a low-temperature environment, the signal processing circuit element 8 does not contact the module casing 2. Accordingly, the heat generated in the signal processing circuit element 8 does not escape, resulting in that the temperature of the signal processing circuit element 8 is maintained within the operational temperature range.

As described above, in this embodiment, under a low-temperature environment, the signal processing circuit element 8 does not release the heat it generates. Accordingly, the temperature of the signal processing circuit element 8 is maintained within the operational temperature range, thereby preventing a malfunction.

In addition, as in the case of the first to the third embodiments, under a low-temperature environment, it is possible to lower the operational temperature of this embodiment as compared with the conventional optical communication modules. As a result, it is possible to achieve an optical communication module having a wider operational temperature range.

(Fifth Embodiment)

Next, the structure of an optical communication module according to the fifth embodiment of the present invention is shown in FIG. 6. FIG. 6(a) is a sectional view showing the state of the optical communication module of the fifth embodiment under a low-temperature environment. FIG. 6(b) is a sectional view showing the state of the optical communication module of the fifth embodiment under a high-temperature environment.

The optical communication module of the fifth embodiment is achieved by removing the heat conduction plate 10 of the optical communication module of the first embodiment shown in FIG. 1, and by replacing the module casing 2 with a module casing 2A. The module casing 2A is formed by replacing the upper surface of the module casing 2 with a heat conduction plate 12 formed of, for example, a bimetal. Under a low-temperature environment, the heat conduction plate 12 is flat as shown in FIG.6(a). However, under a high-temperature environment, the heat conduction plate 12 curves toward the lower surface of the module casing 2 to become a concave shape, so as to contact the signal processing circuit element 8 formed on the printed circuit board 5.

In the optical communication module of this embodiment, under a high-temperature environment, the heat conduction plate 12 serving as the upper surface of the module casing 2A bends so as to contact the signal processing circuit element 8. Accordingly, the heat generated in the signal processing circuit element 8 escapes to the outside via the upper surface of the module casing 2, resulting in that the temperature of the signal processing circuit element 8 is maintained within the operational temperature range.

Under a low-temperature environment, the signal processing circuit element 8 does not contact the upper surface 12 of the module casing 2. Accordingly, the heat generated in the signal processing circuit element 8 does not escape, resulting in that the temperature of the signal processing circuit element 8 is maintained within the operational temperature range.

As described above, in this embodiment, under a low-temperature environment, the signal processing circuit element 8 does not release the heat it generates. Accordingly, the temperature of the signal processing circuit element 8 is maintained within the operational temperature range, thereby preventing a malfunction.

In addition, as in the case of the first to the fifth embodiments, under a low-temperature environment, it is possible to lower the operational temperature of this embodiment as compared with the conventional optical communication modules. As a result, it is possible to achieve an optical communication module having a wider operational temperature range.

Although the light sent to/from the conversion element 6 is transmitted via the optical fiber 4 in the first to the fourth embodiment, the present invention is not limited thereto. For example, it is possible to transmit the light directly through the air by using, for example, far infrared ray.

As described above, according to the present invention, under a low-temperature environment, the heat generated in the signal processing circuit element does not escape. Accordingly, the temperature of the signal processing circuit element can be maintained within the operational temperature range, thereby preventing a malfunction.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. An optical communication module comprising:
a module casing;
a conversion element housed in said module casing, and performing at least one of conversion from an electric signal to an optical signal and conversion from an optical signal to an electric signal;
a signal processing circuit element performing signal processing, which is housed in said module casing and connected to said conversion element; and
a heat conduction member, which contacts said module casing and said signal processing circuit element when a temperature of an atmosphere in said module casing is above an operational temperature range of said signal processing circuit element, but which parts from said signal processing element when a temperature of the atmosphere in the module casing is below the operational temperature range.

2. The optical communication module according to claim 1, wherein said conversion element and said signal processing circuit element are formed on a printed circuit board, and one end of said heat conduction member is fixed to an upper surface of said module casing.

3. The optical communication module according to claim 1, wherein said conversion element and said signal processing circuit element are formed on a printed circuit board, and one end of said heat conduction member is fixed to a lower surface of said module casing.

4. The optical communication module according to claim 1, wherein:
said conversion element and said signal processing circuit element are formed on a printed circuit board; and
said heat conduction member includes a first heat conduction plate, one end of which is fixed to an upper surface of said module casing, and a second heat conduction plate, one end of which is fixed to a lower surface of said module casing, the other ends of said first heat conduction plate and said second heat conduction plate contacting said signal processing circuit element when the temperature in said module casing is above said operational temperature range, but parting from said signal processing circuit element when the temperature in said module casing is below said operational temperature range.

5. The optical communication module according to claim 1, wherein:
said heat conduction member serves as an upper surface of said module casing; and
said conversion element and said signal processing circuit element are formed on a printed circuit board which bends in accordance with temperature, said printed circuit board being flat when the temperature of the atmosphere in said module casing is below the operational temperature range of said signal processing circuit element, and said printed circuit board bending toward the upper surface of said module casing so as to become a convex shape to allow said signal processing circuit element to contact the upper surface of said module casing when the temperature of the atmosphere in said module casing is above the operational temperature range.

6. The optical communication module according to claim 1, wherein said heat conduction member serves as an upper surface of said module casing, said heat conduction member being flat when the temperature of the atmosphere in said module casing is below the operational temperature range of said signal processing circuit element, and said heat conduction member bending toward a lower surface of said module casing so as to become a concave shape to contact said signal processing circuit element when the temperature of the atmosphere in said module casing is above the operational temperature range.
